(19) United States
(12) Patent Application Publication
(10) Pub. No.: US 2021/0291949 A1
(43) Pub. Date: Sep. 23, 2021

(54) SEALING STRUCTURE

(71) Applicant: HONDA MOTOR CO., LTD., Tokyo (JP)

(72) Inventors: Tsuyoshi Yoshigasaki, Wako-shi (JP); Yoshihiro Harada, Wako-shi (JP)

(73) Assignee: HONDA MOTOR CO., LTD., Tokyo (JP)

(21) Appl. No.: 17/183,637

(22) Filed: Feb. 24, 2021

(30) Foreign Application Priority Data
Mar. 19, 2020 (JP) 2020-049523

(51) Int. Cl. B63H 20/32; F16J 15/10

(52) U.S. Cl. CPC B63H 20/32; F16J 15/104

(57) ABSTRACT

A sealing structure of a cover for covering an outboard engine, the cover being formed by combining not less than three cover members, and having an intersection where combining portions of the three cover members intersect each other in the form of a T-shape, the sealing structure includes a first linear sealing member passing through the intersection, a second linear sealing member extending from the intersection, and a block-like sealing portion arranged in the intersection, having a passage portion through which the first linear sealing member passes, and having a connecting portion for connecting an end portion of the second linear sealing member.

### CROSS-REFERENCE TO RELATED APPLICATION(S)

This application claims priority to and the benefit of Japanese Patent Application No. 2020-049523 filed on Mar. 19, 2020, the entire disclosure of which is incorporated herein by reference.

### BACKGROUND OF THE INVENTION

### Field of the Invention

The present invention relates to a sealing structure of the cover of an outboard engine.

### Description of the Related Art

An outboard engine is covered with a cover from the viewpoint of waterproofing. A sealing structure is formed to improve the water cutoff performance of the cover (for example, Japanese Patent Laid-Open No. 8-99694).

It is necessary to detach and attach the cover of the outboard engine in order to perform start-up inspection or maintenance. If the cover is formed by one member, the size and weight of the member increase the work load of a worker. In particular, the cover of a large-sized engine is large and heavy, so the work load of a worker further increases. Therefore, it is possible to form the cover by combining a plurality of members. In this case, the cover is disassembled and then assembled again when detaching and attaching it. However, this dividable structure of the cover requires sealing between the members. In particular, a portion combining three members has a T-shape, so it is necessary to sufficiently ensure the sealability in this portion.

### SUMMARY OF THE INVENTION

It is an object of the present invention to provide a sealing structure that improves the sealability of a T-shaped combining portion.

According to an aspect of the present invention, there is provided a sealing structure of a cover for covering an outboard engine, the cover being formed by combining not less than three cover members, and having an intersection where combining portions of the three cover members intersect each other in the form of a T-shape, the sealing structure comprising: a first linear sealing member passing through the intersection; a second linear sealing member extending from the intersection; and a block-like sealing portion arranged in the intersection, having a passage portion through which the first linear sealing member passes, and having a connecting portion for connecting an end portion of the second linear sealing member.

Further features of the present invention will become apparent from the following description of exemplary embodiments (with reference to the attached drawings).

### BRIEF DESCRIPTION OF THE DRAWINGS

FIG. 1 is a side view showing the overall structure of an outboard engine;

FIG. 2 is an exploded perspective view schematically showing the structures of an inner cover and an outer cover;

FIG. 3 is an exploded perspective view schematically showing a sealing structure according to an embodiment of the present invention;

FIG. 4A is a perspective view of sealing members;

FIG. 4B is a view showing a modification of the sealing member;

FIG. 4C is a view showing an example of the material of the sealing members;

FIG. 5 is a front view of an upper cover;

FIG. 6A is a sectional view taken along a line A-A in FIG. 5;

FIG. 6B is a sectional view taken along the line A-A in FIG. 5, from which the sealing structure is excluded;

FIG. 6C is a sectional view taken along a line B-B in FIG. 5;

FIG. 7A is a sectional view taken along a line C-C in FIG. 5;

FIG. 7B is a sectional view taken along a line D-D in FIG. 5; and

FIGS. 8A and 8B are sectional views showing other examples of the sealing member.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

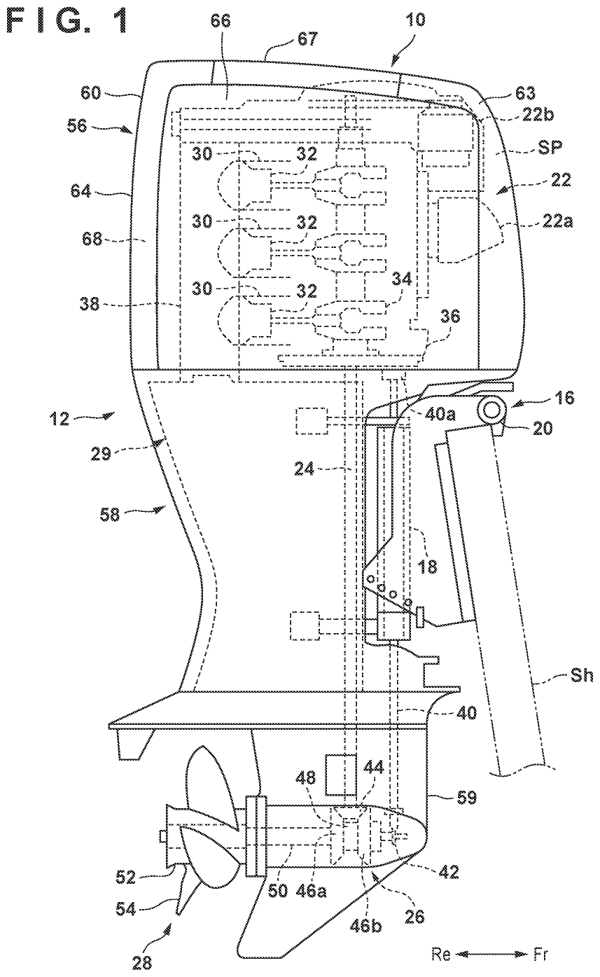

FIG. 1 is a side view of an outboard engine 10 using a cover 12 having a structure according to an embodiment of the present invention. The outboard engine 10 is attached to a ship hull Sh as a power source of a small ship or the like, and propels the ship hull Sh by being driven by a user's operation. In FIG. 1, Fr indicates the front side in the front-and-rear direction of the outboard engine 10, and Re indicates the rear side. When mentioning the direction of the outboard engine 10, this direction means a direction when the outboard engine 10 is mounted on the ship hull Sh (particularly a direction in the posture when the outboard engine 10 is operated with a crank shaft 34 pointing in the vertical direction as shown in FIG. 1).

The outboard engine 10 is fixed to the ship hull Sh via an attaching mechanism 16. The attaching mechanism 16 can swing the outboard engine 10 around a swivel shaft 18, and can swing the outboard engine 10 clockwise or counterclockwise around a tilt shaft 20. Fins 54 are positioned underwater when the outboard engine 10 is in the posture shown in FIG. 1.

The cover 12 has an engine 22, a drive shaft 24, a gear mechanism 26, and a propeller mechanism 28 inside. Also, below the engine 22, the outboard engine 10 has an exhaust system (not shown) for causing the exhaust gas of the engine 22 to flow, and a cooling structure 29 for cooling the engine 22 and the exhaust gas.

The cooling structure 29 is formed by, for example, stacking a plurality of cases inside the cover 12. The cooling structure 29 can have a silencing function that is implemented by causing cooling water (seawater or fresh water obtained from outside the outboard engine 10) to flow around the exhaust pipe (not shown) of the exhaust gas.

The engine 22 is a multicylinder engine (for example, a V-type engine) including a plurality of cylinders 30 along the vertical direction of the outboard engine 10. The engine 22 has a structure in which the axis of each cylinder 30 is arranged sideways (almost horizontally). The crank shaft 34 to be coupled with a connecting rod 32 of each cylinder 30 is extended in the vertical direction. Water jackets are formed for a cylinder block 36 and a cylinder head 38 of the engine 22, and can cool these members by using the cooling water of the cooling structure 29.

The crank shaft 34 is coupled with the upper end of the drive shaft 24. The drive shaft 24 is extended in the vertical direction inside the cover 12, and rotated together with the rotation of the crank shaft 34. The lower end of the drive shaft 24 enters the gear mechanism 26. When an operation shaft 40 is operated, the gear mechanism 26 rotates the propeller mechanism 28 by switching the driving forces of the engine 22, thereby moving the ship hull Sh forward or backward. The operation shaft 40 is rotated by, for example, a shift actuator 40a that is driven in accordance with a user's shift operation.

When the operation shaft 40 rotates, the gear mechanism 26 moves a shift slider 42 forward or backward in the axial direction of a propeller shaft 50. Consequently, the shift slider 42 moves a dog clutch 48 between a forward driven bevel gear 46a and a backward driven bevel gear 46b that mesh with a driving bevel gear 44 coupled to the drive shaft 24. When the tooth surface of the dog clutch 48 meshes with one of the inside tooth surface of the forward driven bevel gear 46a and the inside tooth surface of the backward driven bevel gear 46b, the driving force of the engine 22 is transmitted to the propeller mechanism 28 via the dog clutch 48 and the propeller shaft 50.

The propeller mechanism 28 includes the cylindrical propeller shaft 50 into which the shift slider 42 is inserted, a cylindrical member 52 coupled with the outside of the propeller shaft 50 in the radial direction, and the plurality of fins 54 coupled with the outer circumferential surface of the cylindrical member 52. The propeller mechanism 28 rotates the fins 54 clockwise or counterclockwise around the propeller shaft 50 rotated by the gear mechanism 26, thereby moving the ship hull Sh forward or backward.

The cover 12 includes an upper cover 56 mainly covering the engine 22 positioned in the upper portion of the outboard engine 10, and a lower cover 58 mainly covering members below the engine 22. For example, the upper cover 56 and the lower cover 58 are fixed to a mount frame (not shown) for mounting the engine 22, and divided from the mount frame as the boundary. A gear case 59 forming the gear mechanism 26 is coupled with the lower end of the lower cover 58.

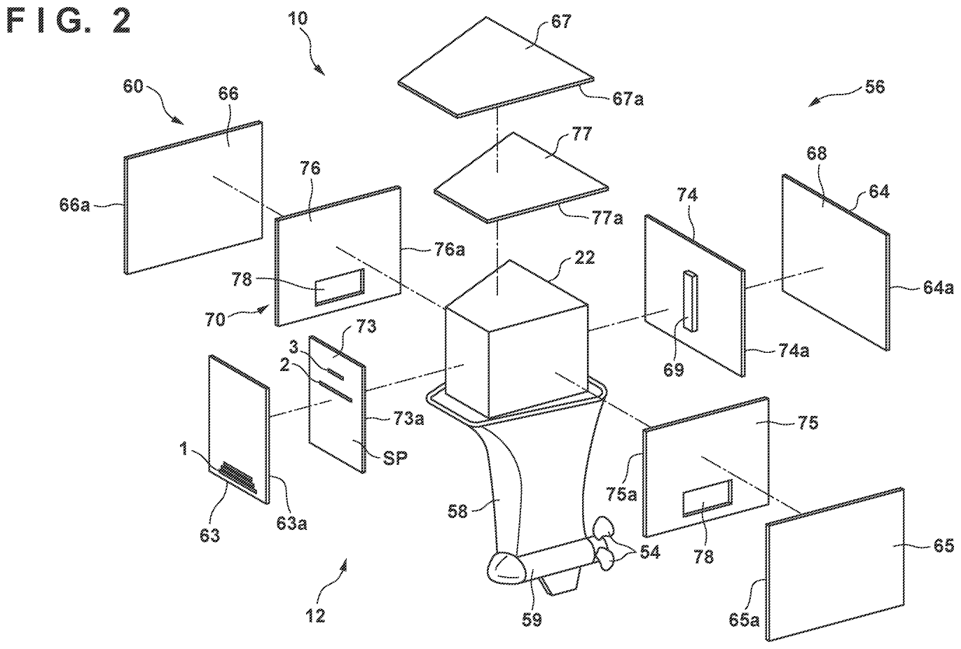

The upper cover 56 is a hollow body covering the front and rear sides, the left and right sides, and the upper and lower sides of the engine 22, and has a double structure including an outer cover 60 on the outside and an inner cover 70 on the inside. The outer cover 60 has a dividable structure formed by a plurality of members, and the inner cover 70 also has a dividable structure formed by a plurality of members. FIG. 2 is an exploded perspective view schematically showing members of the inner cover 70 and the outer cover 60. In this embodiment, the inner cover 70 and the outer cover 60 each form a hollow body covering the engine 22.

The outer cover 60 is formed by combining an outer front surface portion 63, an outer rear surface portion 64, an outer left side surface portion 65, an outer right side surface portion 66, and an outer upper surface portion 67, and each portion is formed by a panel-like cover member. The outer front surface portion 63 covers the front surface of the engine 22, and the outer rear surface portion 64 covers the rear surface of the engine 22. The outer left side surface portion 65 covers the left side surface of the engine 22, and the outer right side surface portion 66 covers the right side surface of the engine 22. The outer upper surface portion 67 covers the upper surface of the engine 22.

An edge 63a of the outer front surface portion 63, an edge 64a of the outer rear surface portion 64, an edge 65a of the outer left side surface portion 65, an edge 66a of the outer right side surface portion 66, and an edge 67a of the outer upper surface portion 67 are detachably attached to each other by a fixing structure (not shown), for example, an engaging structure or a fastening structure such as screw clamp.

The inner cover 70 is formed by combining an inner front surface portion 73, an inner rear surface portion 74, an inner left side surface portion 75, an inner right side surface portion 76, and an inner upper surface portion 77, and each portion is formed by a panel-like cover member. The inner front surface portion 73 is positioned between the outer front surface portion 63 and the front surface of the engine 22, and covers the front surface of the engine 22. The inner rear surface portion 74 is positioned between the outer rear surface portion 64 and the rear surface of the engine 22, and covers the rear surface of the engine 22. The inner left side surface portion 75 is positioned between the outer left side surface portion 65 and the left side surface of the engine 22, and covers the left side surface of the engine 22. The inner right surface portion 76 is positioned between the outer right surface portion 66 and the right side surface of the engine 22, and covers the right surface portion of the engine 22. The inner upper surface portion 77 is positioned between the outer upper surface portion 67 and the upper surface of the engine 22, and covers the upper surface of the engine 22.

An edge 73a of the inner front surface portion 73, an edge 74a of the inner rear surface portion 74, an edge 75a of the inner left side surface portion 75, an edge 76a of the inner right side surface portion 76, and an edge 77a of the inner upper surface portion 77 are detachably attached to each other by a fixing structure (not shown), for example, an engaging structure or a fastening structure such as screw clamp.

Openings 78 for maintenance of the engine 22 are formed in the inner left side surface portion 75 and the inner right side surface portion 76. Maintenance of the engine 22 can be performed through the openings 78 by detaching the outer cover 60. A space 68 between the inner rear surface portion 74 and the outer rear surface portion 64 forms a part of an intake air passage. A silencer 69 for reducing the air intake noise is formed on the inner rear surface portion 74.

An intake 1 for outer air is formed in the lower portion of the outer front surface portion 63, and a flow space SP for air taken in from the intake 1 is formed between the outer front surface portion 63 and the inner front surface portion 73. In the inner front surface portion 73, communication ports 2 and 3 are formed above the intake 1. The communication ports 2 and 3 are slit-like openings extending through the inner front surface portion 73 in the thickness direction, and make the internal space of the inner cover 70 accommodating the engine 22 communicate with the flow space SP. Air taken in from the intake 1 is supplied to the engine 22 through the flow space SP and the communication ports 2 and 3, and used as air for cooling or air supply. For example, the air cools accessories 22a and electric parts 22b such as a control circuit of the engine 22.

Since the intake 1 is formed in the outer front surface portion 63 forming the front surface of the outer cover 60, the navigation wind is easily taken in during navigation. It is also possible to prevent water from entering the engine 22 because the intake 1 is formed in the lower portion of the outer front surface portion 63, which is the upper portion of the stem of the ship hull Sh where water does not easily enter.

<Sealing Structure>

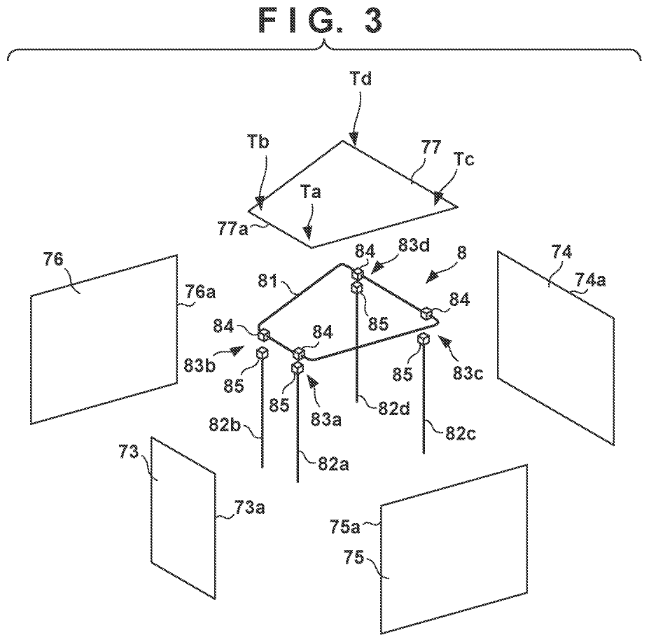

The inner cover 70 is formed by the plurality of cover members. If water enters the inner cover 70 from the gaps between the members, this water causes rust or the like of the engine 22. In this embodiment, a sealing structure 8 shown in FIG. 3 is formed in the inner cover 70. FIG. 3 is an exploded perspective view schematically showing the sealing structure 8.

The sealing structure 8 includes linear sealing members 81 and 82a to 82d, and block-like sealing portions 83a to 83d formed by block-like sealing members 84 and 85. In this embodiment, the sealing member 81 is an endless sealing member, and is an annular member formed over the whole circumference of the edge 77a of the inner upper surface portion 77. The sealing member 81 is a solid elastic member having a circular section, and made of, for example, rubber or a resin. The sectional shape of the sealing member 81 is not limited to a circle, and may also be another shape such as a rectangular shape, a recessed shape, or a projecting shape. The sealing member 81 forms seals between the edge 77a of the inner upper surface portion 77 and the upper edges, that is, the edge 73a of the inner front surface portion 73, the edge 74a of the inner rear surface portion 74, the edge 76a of the inner right side surface portion 76, and the edge 75a of the inner left side surface portion 75. Note that the sealing member 81 is an endless member in this embodiment, but the sealing member 81 may also be formed by a plurality of members having end portions. However, the number of parts can be reduced when the sealing member 81 is an endless member.

The sealing members 82a to 82d are sealing members having end portions. In this embodiment, the sealing members 82a to 82d are solid elastic members made of the same material as that of the sealing member 81. The sealing member 82a forms a seal between the side edge of the edge 73a of the inner front surface portion 73 and the side edge of the edge 75a of the inner left side surface portion 75. The sealing member 82b forms a seal between the side edge of the edge 73a of the inner front surface portion 73 and the side edge of the edge 76a of the inner right side surface portion 76. The sealing member 82c forms a seal between the side edge of the edge 74a of the inner rear surface portion 74 and the side edge of the edge 75a of the inner left side surface portion 75. The sealing member 82d forms a seal between the side edge of the edge 74a of the inner rear surface portion 74 and the side edge of the edge 76a of the inner right side surface portion 76. The sealing members 82a to 82d will be called sealing members 82 when they are collectively referred to or it is unnecessary to distinguish between them.

The inner cover 70 has intersections Ta to Td in each of which the combining portions of three cover members intersect each other in the form of a T-shape. In this embodiment, the intersections Ta to Td are positioned in the four corners of the inner upper surface portion 77. If the sealing members 81 and 82 are simply routed in the form of a T-shape in the intersections Ta to Td, it is sometimes impossible to obtain a sufficient seal due to the lack of contact between them. Therefore, the block-like sealing portions 83a to 83d are arranged spotwise in the intersections Ta to Td. The sealing portions 83a to 83d will be called sealing portions 83 when they are collectively referred to or it is unnecessary to distinguish between them.

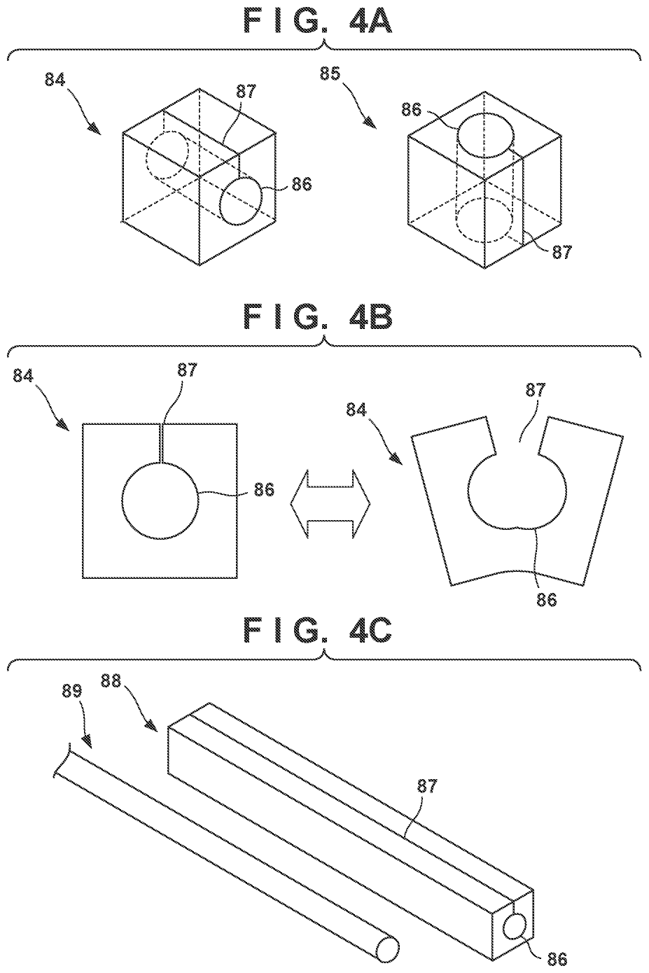

The sealing member 81 passes through the sealing portion 83, and the end portion of the sealing member 82 is connected to the sealing portion 83. This improves the sealability of the intersections Ta to Td. Each sealing portion 83 is formed by block-like sealing members 84 and 85. FIG. 4A is a perspective view of the sealing member 84. The sealing member 84 is a cubic elastic member and made of, for example, rubber or a resin. The sealing member 84 has a through hole 86 that extends through two opposing surfaces of the six surfaces. The through hole 86 is a passage portion because the sealing member 81 passes through the sealing member 84 by passing through the through hole 86. Since the sealing member 81 passes through the through hole 86, it is possible to prevent falling of the sealing member 81 from the sealing member 84.

The sealing member 84 has a cut 87 formed from the through hole 86 to the surface of the sealing member 84. When passing the sealing member 81 through the through hole 86, the endless sealing member 81 can be attached to the through hole 86 from the side portion of the through hole 86 by elastically deforming the sealing member 84 so as to open the cut 87 as shown in FIG. 4B.

FIG. 4B is a perspective view of the sealing member 85. In this embodiment, the sealing members 84 and 85 are identical members. This makes it possible to reduce the number of types of parts. However, the sealing members 84 and 85 may also be different members. The end portion of the sealing member 82 is inserted into the through hole 86 of the sealing member 85, and the two members are connected. Accordingly, the through hole 86 of the sealing member 85 is a connecting portion for the sealing member 82.

As shown in FIG. 4C, the sealing members 84 and 85 can be formed by cutting out them from an elongated member 88 as a common material. The elongated member 88 has the through hole 86 and the cut 87 that extend through the two end faces of the elongated member 88. The sealing member 84 or 85 can be obtained by cutting the elongated member 88 in an appropriate position in the longitudinal direction.

Likewise, as shown in FIG. 4C, the sealing members 81 and 82 can be formed by cutting out them from an elongated member 89 as a common material. The sealing members 81 and 82 can be obtained by cutting the elongated member 89 in appropriate positions in the longitudinal direction. The sealing member 81 can be obtained by further connecting the two ends of the cutout material.

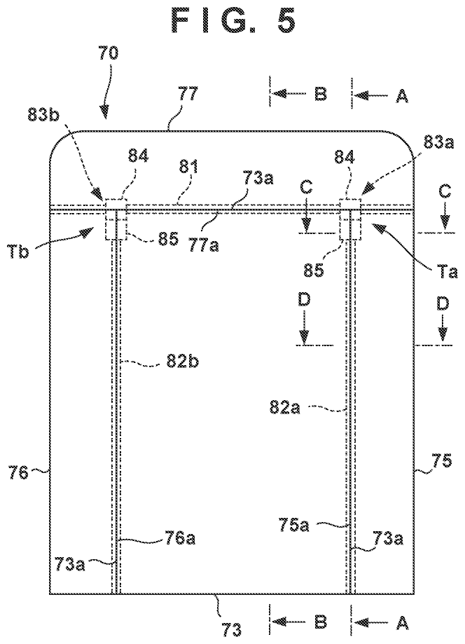

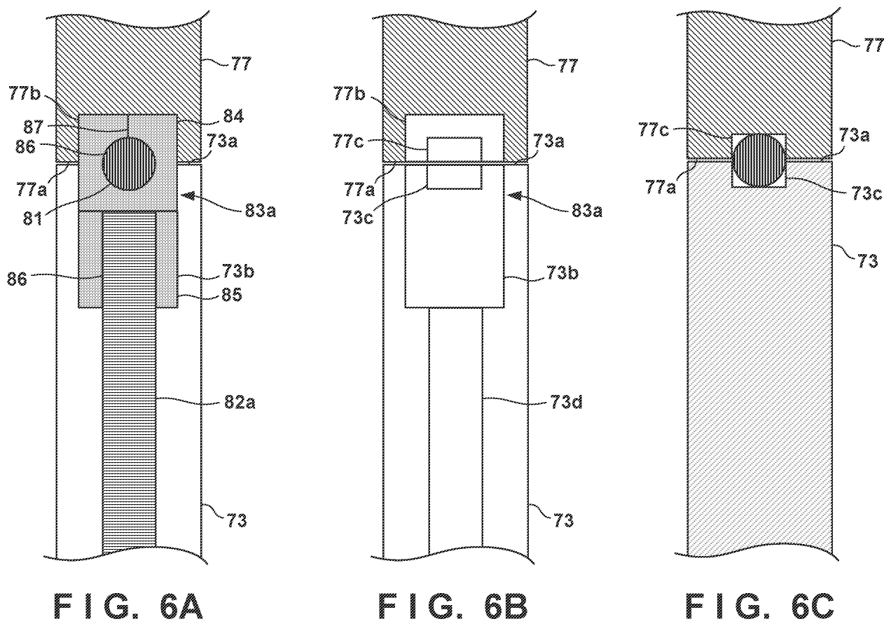

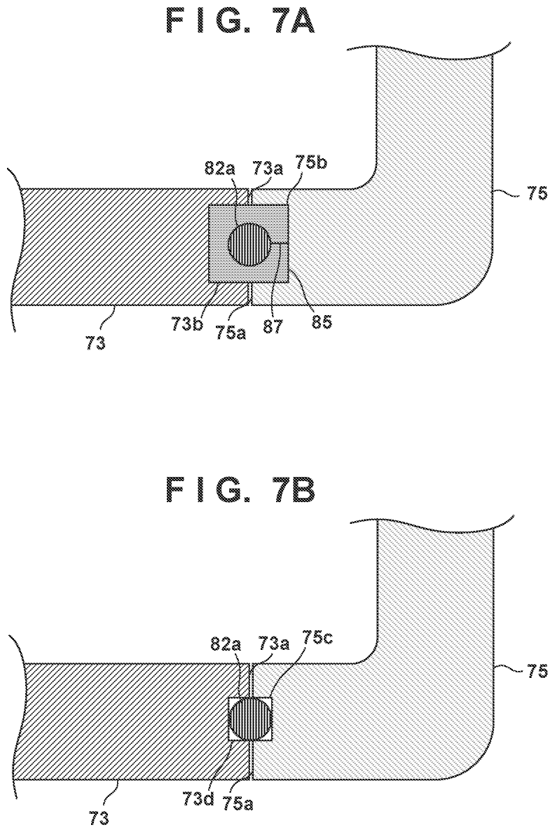

FIG. 5 is a front view of the inner cover 70 (a view showing the inner cover 70 from the front side of the outboard engine 10), and shows the sealing structure 8 when assembling the inner cover 70. FIG. 6A is a sectional view taken along a line A-A in FIG. 5. FIG. 6B is a sectional view taken along the line A-A in FIG. 5, from which the sealing members 81, 82a, 84, and 85 are omitted. FIG. 6C is a sectional view taken along a line B-B in FIG. 5. FIG. 7A is a sectional view taken along a line C-C in FIG. 5. FIG. 7B is a sectional view taken along a line D-D in FIG. 5. The structure and the like of a seal in the intersection Ta will be explained below, but the same explanation applies to the intersections Tb and Tc as well.

The edge 77a of the inner upper surface portion 77 has a groove 77b for accommodating the upper side portion of the sealing member 84, and a groove 77c for accommodating the upper side portion of the sealing member 81, and these grooves communicate with each other. The edge 73a of the inner front surface portion 73 has a groove 73b for accommodating the lower and right side portions of the sealing member 84 and the right side portion of the sealing member 85, a groove 73c for accommodating the lower side portion of the sealing member 81, and a groove 73d for accommodating the right side portion of the sealing member 82a. The edge 75a of the inner left side surface portion 75 has a groove 75b for accommodating the lower and left side portions of the sealing member 84 and the left side portion of the sealing member 85, a groove (not shown, similar to the groove 73c) for accommodating the lower side portion of the sealing member 81, and a groove 75d for accommodating the left side portion of the sealing member 82a.

The sealing members 84 and 85 are accommodated in the grooves 77b, 73b, and 75b as they are arranged in the vertical direction, and the lower surface of the sealing member 84 and the upper surface of the sealing member 85 come in contact with each other. When the inner upper surface portion 77 is locked to the inner front surface portion 73 and the inner left side surface portion 75, the sealing members 84 and 85 are compressed in the vertical direction and brought into tight contact with each other, and the other surfaces of the sealing members 84 and 85 are also brought into tight contact with the inner wall surfaces of the grooves 77b, 73b, and 75b. This forms a seal.

The sealing member 81 is accommodated in the groove 77c, the groove 73c, and the groove (not shown) formed in the edge 75a of the inner left side surface portion 75, and brought into tight contact with the inner wall surfaces of these grooves when the inner upper surface portion 77 is locked to the inner front surface portion 73 and the inner left side surface portion 75. This forms a seal.

The sealing member 82a is accommodated in the grooves 73d and 75d and brought into tight contact with the inner wall surfaces of these grooves when the inner front surface portion 73 and the inner left side surface portion 75 are locked to each other. This forms a seal.

As described above, this embodiment can improve the sealability in the intersection Ta. This applies to the intersections Tb and Tc as well. Since the cubic members are used as the sealing members 84 and 85, the degree of freedom of the shape of an arrangement portion is high, and this can implement various dividable forms of the cover 70.

### Second Embodiment

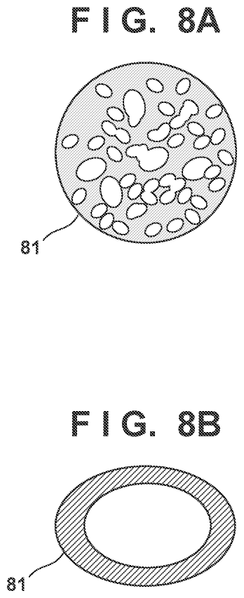

The sealing members 81 and 82 may also be porous elastic members such as foamed members, or hollow elastic members. FIG. 8A is a sectional view of another material example of the sealing member 81, and shows a porous elastic member. An example of the porous elastic member is foamed urethane. FIG. 8B is also a sectional view of another material example of the sealing member 81, and shows a hollow elastic member. In this example, a cavity is formed in the center of the sealing member 81, so the sealing member 81 has an elliptic cylindrical shape as a whole. Thus, various elastic members can be used as the sealing members 81 and 82.

### Third Embodiment

In the first embodiment, the block-like sealing portion 83 is formed by the two block-like sealing members 84 and 85. However, the block-like sealing portion 83 may also be formed by one block-like sealing member. One block-like sealing member can also be, for example, a member obtained by integrating the block-like sealing members 84 and 85.

The two block-like sealing members 84 and 85 are members having the same shape in the first embodiment, but they may also be different. For example, the two block-like sealing members 84 and 85 may also be rectangular parallelepiped members having different dimensions. In addition, the two block-like sealing members 84 and 85 are not limited to a cubic shape or a rectangular parallelepiped shape, and may also have a spherical shape.

### Summary of Embodiments

The abovementioned embodiments disclose at least the following sealing structures.

1. A sealing structure according to the above embodiment is a sealing structure (8) of a cover (70) for covering an outboard engine (22), the cover (70) being formed by combining not less than three cover members (73-77), and having an intersection (Ta-Td) where combining portions of the three cover members intersect each other in the form of a T-shape, the sealing structure (8) comprising:
a first linear sealing member (81) passing through the intersection;
a second linear sealing member (82a-82d) extending from the intersection; and
a block-like sealing portion (83a-83d) arranged in the intersection, having a passage portion (86) through which the first linear sealing member passes, and having a connecting portion (86) for connecting an end portion of the second linear sealing member.

This embodiment can provide a sealing structure that improves the sealability of the T-shaped combining portion.

2. In the above embodiment,
the block-like sealing portion (83a-83d) includes:
a first block-like sealing member (84) having the passage portion (86); and
a second block-like sealing member (85) configured to come in contact with the first block-like sealing member (84), and having the connecting portion (86).

This embodiment can implement various assembling forms of the cover members.

3. In the above embodiment,
the first block-like sealing member (84) and the second block-like sealing member (85) have a cubic shape, and one surface of the first block-like sealing member and one surface of the second block-like sealing member come in contact with each other.

This embodiment can form a seal by the surface pressure while increasing the versatility.

4. In the above embodiment,
the passage portion is a through hole (86) extending through the block-like sealing portion (83a-83d).

This embodiment can prevent falling of the first linear sealing member.

5. In the above embodiment,
the block-like sealing portion (83a-83d) has a cut (87) formed from the through hole (86) to a surface of the block-like sealing portion.

This embodiment facilitates attaching the first linear sealing member to the block-like sealing portion.

6. In the above embodiment,
the first linear sealing member (81) is an endless member.

This embodiment can reduce the number of parts.

7. In the above embodiment,
the first linear sealing member (81) and the second linear sealing member (82a-82d) are solid elastic members.

8. In the above embodiment,
the first linear sealing member (81) and the second linear sealing member (82a-82d) are porous elastic members.

9. In the above embodiment,
the first linear sealing member (81) and the second linear sealing member (82a-82d) are hollow elastic members.

10. In the above embodiment,
the first linear sealing member (81) and the second linear sealing member (82a-82d) are members cut out from an elongated material (89) as a material thereof.

This embodiment facilitates preparation of each linear sealing member easier.

11. In the above embodiment,
the first block-like sealing member (84) and the second block-like sealing member (85) are identical members, and the passage portion and the connecting portion are through holes.

This embodiment can reduce the number of types of parts.

The invention is not limited to the foregoing embodiments, and various variations/changes are possible within the spirit of the invention.

What is claimed is:

1. A sealing structure of a cover for covering an outboard engine, the cover being formed by combining not less than three cover members, and having an intersection where combining portions of the three cover members intersect each other in the form of a T-shape, the sealing structure comprising:
a first linear sealing member passing through the intersection;
a second linear sealing member extending from the intersection; and
a block-like sealing portion arranged in the intersection, having a passage portion through which the first linear sealing member passes, and having a connecting portion for connecting an end portion of the second linear sealing member.

2. The structure according to claim 1, wherein
the block-like sealing portion includes:
a first block-like sealing member having the passage portion; and
a second block-like sealing member configured to come in contact with the first block-like sealing member, and having the connecting portion.

3. The structure according to claim 2, wherein the first block-like sealing member and the second block-like sealing member have a cubic shape, and one surface of the first block-like sealing member and one surface of the second block-like sealing member come in contact with each other.

4. The structure according to claim 1, wherein the passage portion is a through hole extending through the block-like sealing portion.

5. The structure according to claim 4, wherein the block-like sealing portion has a cut formed from the through hole to a surface of the block-like sealing portion.

6. The structure according to claim 1, wherein the first linear sealing member is an endless member.

7. The structure according to claim 1, wherein the first linear sealing member and the second linear sealing member are solid elastic members.

8. The structure according to claim 1, wherein the first linear sealing member and the second linear sealing member are porous elastic members.

9. The structure according to claim 1, wherein the first linear sealing member and the second linear sealing member are hollow elastic members.

10. The structure according to claim 2, wherein the first linear sealing member and the second linear sealing member are members cut out from an elongated material as a material thereof.

11. The structure according to claim 2, wherein the first block-like sealing member and the second block-like sealing member are identical members, and the passage portion and the connecting portion are through holes.
